(19) United States
(12) Patent Application Publication
(10) Pub. No.: US 2024/0054908 A1
(43) Pub. Date: Feb. 15, 2024

(54) System and method of writing or typing positive affirmation(s)

(71) Applicant: Nada Jamal, Hamilton (CA)

(72) Inventor: Nada Jamal, Hamilton (CA)

(21) Appl. No.: 18/353,543

(22) Filed: Jul. 17, 2023

Related U.S. Application Data
(60) Provisional application No. 63/371,076, filed on Aug. 11, 2022.

(51) Int. Cl. G09B 7/02; G09B 3/02

(52) U.S. Cl. CPC G09B 7/02; G09B 3/02

(57) ABSTRACT

The present specification discloses a system comprising one or more surface(s) that are comprised of one or more stated positive affirmation(s) and one or more designated area(s) for user to freehand write or type stated positive affirmation(s), and an associated method comprising the step of writing freehand or typing stated positive affirmation(s) in designated area(s) on one or more surface(s).

The following specification particularly describes the invention and the manner in which it is to be performed. The present invention relates generally to areas of positive psychology and self-improvement.

According to the Cambridge Dictionary, an affirmation is defined as either a statement or sign that something is true; or the act of saying yes or of showing that you mean yes.

There is an increasing demand for self-growth and self-improvement content as mental health challenges become more prevalent.

Positive affirmations have been proven to reinforce concepts and influence the mind against mental health challenges. Positive affirmations increase self-awareness of thought patterns so that one is better able to identify negative thought patterns and replace them with positive ones. An example of a positive affirmation is “I am grateful”.

There are various research studies that show the benefits of positive affirmations by means of activation of brain systems such as the ventral striatum and prefrontal cortex, which are associated with self-related processing, valuation and stress. The results of these studies show that positive affirmations heighten self-confidence and self-control, improve reward and prospection processing, buffer stress response, and impact sedentary behaviour via physical activity promotion. They can have lasting benefits with reinforcement upon repeated use.

A highly cited scholar in psychology, Dr. Barbara Fredrickson, has been foundational within positive psychology by providing a blueprint for how pleasant emotional states contribute to resilience, wellbeing and health. She has created what is known as the Broaden-And-Build Theory of Positive Emotions, which explains how positive emotions change your perspective on life and how they can help you accrue valuable emotional resources, such as resilience and mindfulness. Positive affirmations instill positivity and in turn can too instill these valuable emotional resources.

Current available methods to consume positive affirmations include video, audio or print, which incorporate positive affirmations but lack guidance, instruction or room for the practice of writing or typing them. Many processes are vocal-only which, while still beneficial, exclude the additional benefits of writing, typing, guidance and structure.

Current methods also include workbooks containing traceable positive affirmations in order to learn how to handwrite and/or to improve handwriting. Users are directed to trace over words in positive affirmations in order to learn or better handwriting. Our invention uses the freehand writing or typing of positive affirmations for the purpose of enhancing positive feelings and bettering mental well-being. Freehand writing is writing without the use of anything to guide the hand; an example of something to guide the hand is traceable words as used in these current methods.

The present invention provides a means of convenience and direction in utilizing positive affirmations to enhance positive feelings and better mental well-being through the act of freehand writing or typing specified positive affirmation(s). Consumers will not need to reference other publications or spend time searching for and determining positive affirmations best directed towards their goals of self-improvement.

As outlined by scientific research, some of the benefits of writing are increased neural activity in parts of the brain and easier learning. By not simply reading but also engaging in the process through writing or typing, the outcome can result in positive impact and changes in the user. Repeated use can also be effective in positive reinforcement, further driving the impact of the intended cause.

In the present invention, both the number of positive affirmation(s) and the number of times to write the stated positive affirmation(s) will vary. The number of times to write the stated positive affirmation(s) will be specified in instructions that will be provided to the user via the medium being used. For example, if a physical book is being used, the book will include instructions that direct user to either write the positive affirmation(s) a specified number of times or to write the positive affirmation(s) as many times as the user deems fit, guided by user discretion.

Optional elements include but are not limited to reflection pages where users can state their progress or provide a log of improvements they have experienced, fill-in-the-blank statements and/or journal prompts, which can lead to further insight.

Objects of the invention are not limited to the specific features or acts described in the description and drawings.

There now follows, a detailed description, which is to be read with reference to the accompanying drawings in which:

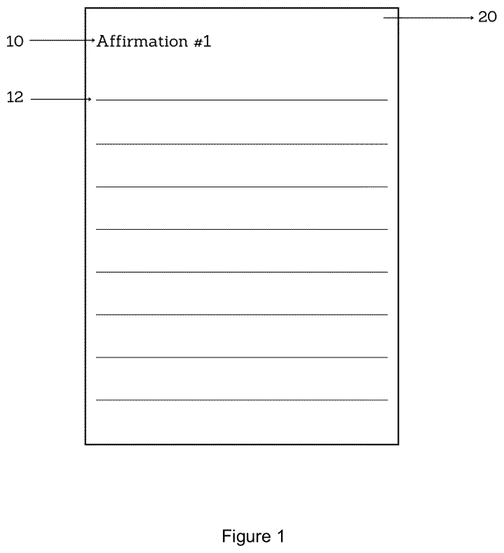

FIG. 1 is a page in a book with a variation of one positive affirmation on a page;

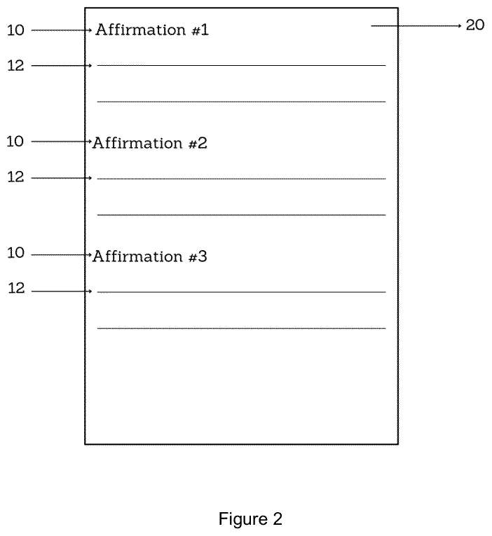

FIG. 2 is a page in a book with a variation of three positive affirmations on a page;

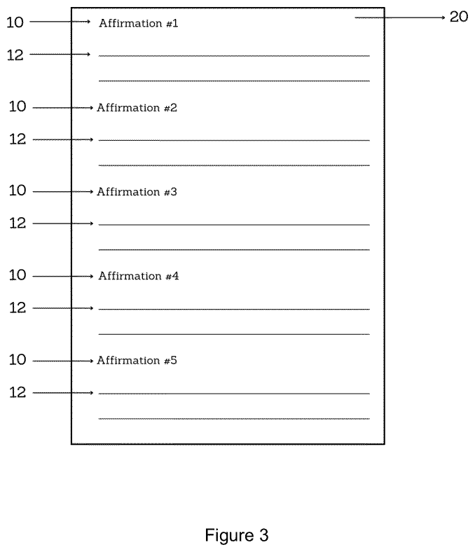

FIG. 3 is a page in a book with a variation of five positive affirmations on a page;

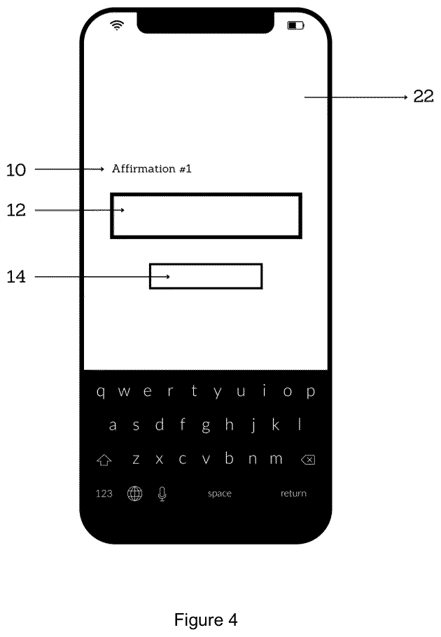

FIG. 4 is an app or web app variation on a mobile device;

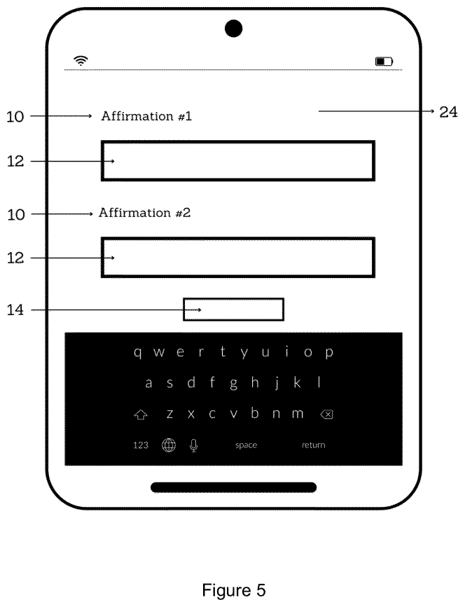

FIG. 5 is an app or web app variation on a tablet; and,

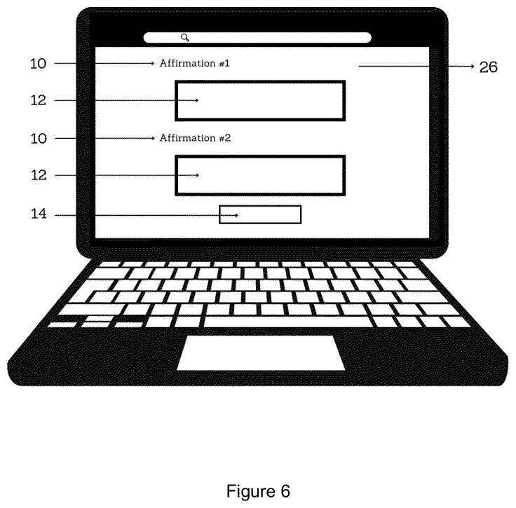

FIG. 6 is an app or web app variation on a desktop, laptop or other size screen.

Referring to the drawings, users will utilize either a physical or digital book 20 (see FIGS. 1, 2 and 3) or utilize an app or web app on mobile 22, tablet 24 or desktop 26 (see FIGS. 4, 5 and 6 respectively).

In the case of a physical or digital page in a book 20, the user will be presented with one or more positive affirmations 10 on a page with a designated area 12 in which to write them. The number of positive affirmations per page as well as the number of times to rewrite them can vary. An example variation is one affirmation 10 on a page 20 with a designated area 12 in which to write the affirmation one or more times (see FIG. 1). Other example variations include but are not limited to three positive affirmations per page (see FIG. 2) and five positive affirmations per page, see FIG. 3, with spaces 12 to write the specified positive affirmations once each.

In the case of mobile 22, tablet 24 or desktop 26, the user will be presented with one or more positive affirmation(s) 10 on the screen. The user will then type in the designated area 12 provided for each positive affirmation 10. The user will then click or tap a button 14 to submit their entries. Upon submission, the user will proceed and be presented with the next positive affirmation 10 and text space 12 to complete until all number of positive affirmation(s) have been completed as per instructions.

The invention claimed is:

1. A system comprising one or more surface(s) comprised of: (a) one or more stated positive affirmation(s) and (b) one or more designated area(s) for user to freehand write or type said stated positive affirmation(s) one or more number of times to enhance mental well-being.

2. The system of claim 1 wherein said surface(s) is able to be written or typed on such as but not limited to a page in a book, a screen of a digital book, or a screen of a web or mobile application.

3. The system of claim 1 wherein said surface(s) is of any size and/or dimension and/or resolution.

4. The system of claim 1 wherein said designated area(s) is of any size and/or dimension and/or resolution.

5. A method of freehand writing or typing stated positive affirmation(s) one or more number of times comprising the step of: writing freehand or typing stated positive affirmation(s) in designated area(s) on one or more surface(s).

6. The method of claim 5 wherein said surface(s) comprises one or more stated positive affirmation(s) and comprises one or more designated area(s) for user to freehand write or type stated positive affirmation(s) one or more number of times.

7. The method of claim 5 wherein said surface(s) is able to be written or typed on such as, but not limited to, a page in a book, a screen of a digital book, or a screen of a web or mobile application.

8. The method of claim 5 wherein said surface(s) is of any size and/or dimension and/or resolution.

9. The method of claim 5 wherein said designated area(s) is of any size and/or dimension and/or resolution.
